(19) United States
(12) Patent Application Publication
(10) Pub. No.: US 2018/0257088 A1
(43) Pub. Date: Sep. 13, 2018

(54) MAGNETIC SEPARATION RACK FOR CONDUCTING MAGNETIC SEPARATION PROCESSES

(71) Applicant: RITTER GMBH, SCHWABMUENCHEN (DE)

(72) Inventor: FRANK RITTER, EPPISHAUSEN (DE)

(21) Appl. No.: 15/908,161

(22) Filed: Feb. 28, 2018

(30) Foreign Application Priority Data
Mar. 9, 2017 (DE) 20 2017 001 238.3

(51) Int. Cl. B03C 1/28; B01L 9/06

(52) U.S. Cl. CPC B03C 1/288; B03C 2201/26; B03C 2201/18; B01L 9/06

(57) ABSTRACT

A magnetic separation rack made of a plastics material for performing automated magnetic separation processes comprises a base plate in which a matrix of m×n wells is formed, and a comb-like hollow rod plate with a matrix of m×n hollow rods each connected with its upper end to a horizontal carrier plate and having a radially outwardly protruding ring collar on its lower end region. The carrier plate has a recess on the position of placement of each hollow rod, the extension of the recess corresponding at least to the projection of the ring collar onto the carrier plate. Each hollow rod has on its outer circumference a plurality of radial ribs extending along the axis of the hollow rod towards the upper end starting from the ring collar, and their connecting the hollow rod to the carrier plate is in one piece while extending radially through the recess.

### CROSS-REFERENCE TO RELATED APPLICATIONS

This application claims priority to pending German Appl. No. 20 2017 001 238.3, filed Mar. 9, 2017, the contents of which are incorporated herein by reference in its entirety.

### BACKGROUND

The present invention relates to magnetic separation racks made of plastics material as laboratory equipment for performing automated magnetic separation in magnetic separation automata, for example for the purification of proteins or for DNA extraction.

Such magnetic separation racks are fabricated by means of a plastic injection molding technique and are comprised of a base plate forming a matrix of m×n wells, and a comb-like hollow rod plate with a matrix of m×n hollow rods, each connected with its upper open end to a carrier plate, and each being immersed into a well of the base plate during use in order to receive one magnetic rod each. At their lower ends, the hollow rods are enlarged by a radially outwardly extending collar in order to generate a relatively narrow gap locally between the rod and the well wall, in order to have the sample liquid flow through the narrowed gap relatively fast when the rod is moved up and down during use to improve mixing and mass transfer.

In a known embodiment of the rod plate, the hollow rods are each fabricated separately and then connected via their upper open ends to the carrier plate that is also fabricated separately; for this purpose, they are plugged on and connected to a tube socket formed onto the carrier plate. This elaborate fabrication process is required because, due to the extension of the lower end of each hollow rod through the radially protruding ring collar, it is no longer possible to manufacture the carrier plate with the rods in one piece, as this would make demolding no longer possible.

### BRIEF SUMMARY OF THE DISCLOSURE

It is thus an object of the invention to provide an improved magnetic separation rack wherein the whole rod plate can be formed as a one-piece body by means of an injection molding process.

According to the invention, this object is achieved by the arrangement disclosed in claim 1. Advantageous developments of the invention constitute the subject-matter of the sub-claims.

With the magnetic separation rack according to the invention, the hollow rods of the rod plate are no longer connected to the carrier plate over their total circumference, as in the conventional embodiment noted above, i.e., not plugged onto and connected to an annular pipe socket formed onto the carrier plate, respectively. Rather, each hollow rod has on its outer circumference a plurality of e.g. three or four axially extending ribs that extend upwards starting from the radially protruding ring collar on the lower end region of the hollow rod, and are connected to the carrier plate as one piece on the upper end, while the carrier plate has recesses in the shape of ring segments between the individual ribs, the outer diameter of the recesses corresponding at least to the outer diameter of the ring collar on the lower end region of the hollow rod.

This creates a mold design without any undercuts, thus allowing the injection molding of the rod plate body in one piece in a two-part injection mold wherein the two mold halves can be opened and closed in the direction of the axis of the hollow rods.

### BRIEF DESCRIPTION OF THE SEVERAL VIEWS OF THE DRAWINGS

An exemplary embodiment of the invention will be described hereinafter in greater detail with reference to the accompanying drawings, in which:

FIG. 1 shows, in a perspective view, the base plate of a magnetic separation rack according to the invention that comprises a base plate and a rod plate,

FIG. 2 shows, in a perspective view, the rod plate of the magnetic separation rack according to the invention,

FIG. 3 shows the rod plate of FIG. 2 in a side view onto the narrow side, and

FIG. 4 shows an enlarged portion of the rod plate of FIG. 2 comprising two rods.

### DETAILED DESCRIPTION OF THE DISCLOSURE

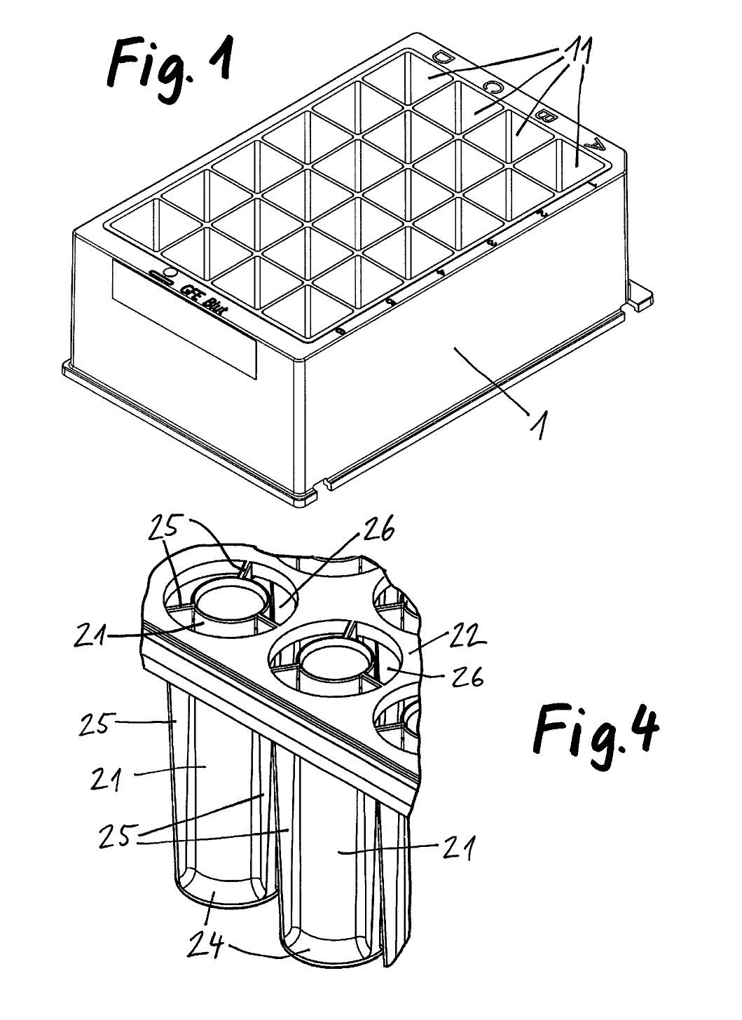

FIGS. 1 and 2 show, in a perspective view respectively, the base plate 1 and the rod plate 2 of a magnetic separation rack according to the invention that is comprised of these two components.

The base plate 1 forms a matrix of m×n, in the exemplary embodiment of 4×6, wells 11, each with a square cross-section profile in its upper region that transitions to a circular cross-section profile in its lower region (not visible in the figure).

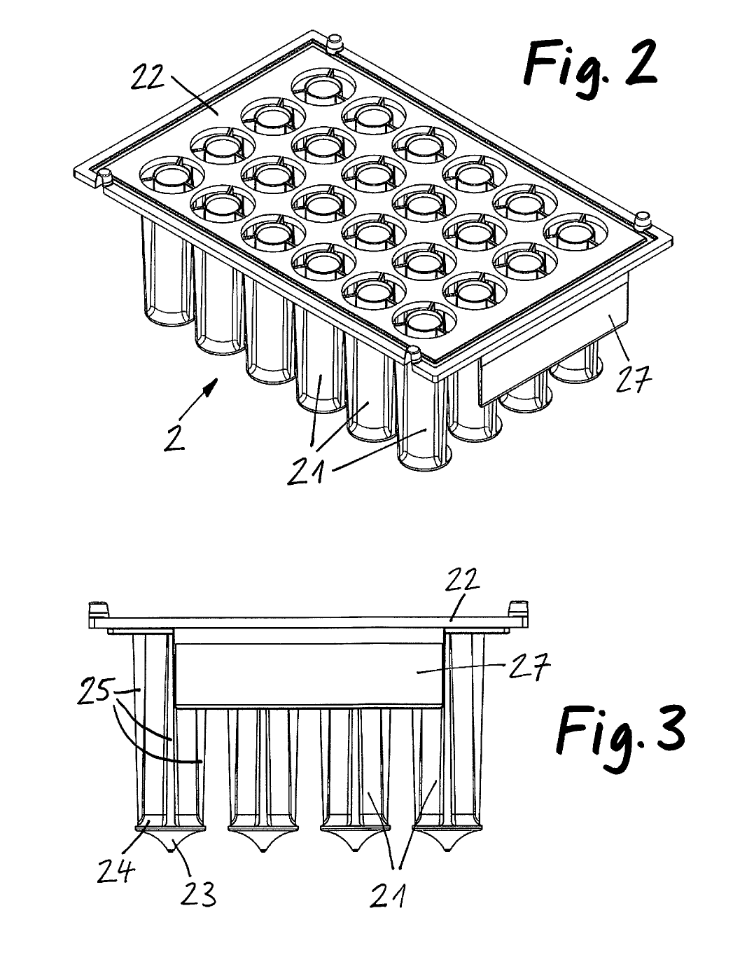

In accordance with the well matrix of the base plate 1, the rod plate 2 also has a matrix of m×n, in the exemplary embodiment 4×6, hollow rods 21 that are connected to a horizontal carrier plate 22 with their upper ends. As can be seen from the lateral view of FIG. 3, each of the hollow rods 21 has a radial enlargement in the shape of a radially protruding ring collar 24 in its lower end region immediately in front of its conical bottom 23. Each of the hollow rods 21 serves to receive a magnetic rod for performing the magnetic separation and is immersed into a corresponding one of the wells 11 of the base plate 1 during use.

As can further be seen in the enlarged portion in FIG. 4, each of the hollow rods 21 has several ribs, in the exemplary embodiment shown here three ribs 25, extending along the outside of the hollow rod 21 in an axial direction. It is also possible to provide e.g. four ribs. These ribs 25 extend from the ring collar 24 on the lower end of the hollow rod 21 (the conical bottom 23 of each rod cannot be seen in FIG. 4) upwards along the outer wall of the hollow rod and terminate on the upper end of the hollow rod 21 flush with surface of the upper side of the carrier plate 22.

The radial extension of the ribs 25 follows the lower end over the radial extension of the respective ring collar 24. On the upper end of each hollow rod 21, the carrier plate 22 has a circular recess 26 having a diameter at least as large as the outer diameter of the ring collar 24 on the lower end of each hollow rod 21. As can be seen most clearly from FIG. 4, the ribs 25 extend on the upper end of each hollow rod 21 radially through the circular recess 26 and thus connect the respective hollow rod 21 to the carrier plate 22. Generally speaking, the areal extension of the recess 26 must correspond at least to the projection of the ring collar 24 onto the carrier plate.

In the exemplary embodiment shown, the ribs 25 slightly enlarge starting from the ring collar 24 upwards toward the carrier plate 22, and correspondingly, the circular recess 26 in the carrier plate 22 into which the upper end of the respective hollow rod 21 is immersed with the upper end of the ribs 25 is slightly larger than the diameter of the ring collar 24.

Due to this arrangement, the whole rod plate can be manufactured in one piece by means of an injection molding process, despite the radially protruding ring collar 24 on the lower part of each rod 21.

As can be seen from FIGS. 2 and 3, the rod plate 2 has a marking carrier plate 27 formed thereon in the shape of a vertical skirt on a least one narrow side, the plate serving for the provision of a label or marking, for example a barcode.

That which is claimed:

1. A magnetic separation rack made of a plastics material for performing automated magnetic separation processes, comprising:
a base plate in which a matrix of m×n wells is formed; and
a comb-like hollow rod plate with a matrix of m×n hollow rods each connected with its upper end to a horizontal carrier plate and having a radially outwardly protruding ring collar on its lower end region;
wherein the carrier plate of the hollow rod plate has a recess on the position of placement of each hollow rod, an extension of the recess corresponding at least to a projection of the ring collar onto the carrier plate, and in that each hollow rod has on its outer circumference a plurality of radial ribs extending along an axis of the hollow rod, the ribs extending towards the upper end of the hollow rod starting from the ring collar, and their connecting the hollow rod to the carrier plate being in one piece while extending radially through the recess of the carrier plate.

2. The magnetic separation rack according to claim 1, wherein the respective recess in the carrier plate is circular and has a diameter corresponding at least to an outer diameter of the ring collar.

3. The magnetic separation rack according to claim 2, wherein the diameter of the recess in the carrier plate is larger than the outer diameter of the ring collar.

4. The magnetic separation rack according to claim 3, wherein the ribs enlarge starting from the ring collar upwards towards the carrier plate.

5. The magnetic separation rack according to claims 1, further comprising a marking carrier plate in a shape of a vertical skirt formed onto at least one edge of the carrier plate.
